(19) United States
(12) Patent Application Publication
(10) Pub. No.: US 2016/0010748 A1
(43) Pub. Date: Jan. 14, 2016

(54) SEALING ASSEMBLY FOR FLAT FLANGE CONNECTIONS

(71) Applicant: Alfred JUNG, Koeln (DE)

(72) Inventor: Alfred JUNG, Koeln (DE)

(21) Appl. No.: 14/771,054

(22) PCT Filed: Apr. 28, 2014
(86) PCT No.: PCT/EP2014/001128

§ 371 Date: Aug. 27, 2015

(30) Foreign Application Priority Data
Jun. 25, 2013 (DE) 20 2013 005 717.3

(51) Int. Cl. F16J 15/08; F16J 15/06

(52) U.S. Cl. CPC F16J 15/0806; F16J 15/0887; F16J 15/061; F16J 15/0881

(57) ABSTRACT

A sealing assembly for flat flange connections includes an annular metal main body, which is composed of a metal sheet, and annular soft-material supports on the two sides. Teeth or corrugations are annularly impressed into the metal main body. The sealing assembly has the following dimension combination in the original state thereof before the installation into the flange connection: the metal sheet thickness of the metal main body is at least 0.5 mm, preferably at least 0.6 mm, more preferably at least 0.8 mm, and even more preferably at least 1.0 mm. The metal sheet thickness of the metal main body is at most 1.5 mm and preferably at most 1.2 mm. The distance between the vertices of each pair of adjacent annular teeth pointing in the same direction is greater than 3 mm and preferably greater than 4 mm. The thickness of the metal main body measured over the vertices of the annular teeth is at least 2 mm and preferably at least 3 mm. The thickness of the metal main body measured over the vertices of the annular teeth is at most 6 mm, preferably at most 5 mm, and even more preferably at most 4 mm.

The invention relates to a sealing assembly for flat flange connections, having a ring-shaped metallic basic body consisting of a metal sheet, and ring-shaped soft-material linings present on both sides, wherein teeth or corrugations are embossed into the metallic basic body in ring shape.

Such embossed sealing assemblies—in other words assemblies not produced by means of chip-removing processing—are already known as such in different variations from the state of the art, for example from EP 1 062 442 B1 or from EP 1 974 158 B1. The sealing assemblies known from the two aforementioned documents are, however, only designed and suitable for narrow flange face gaps of about 2 mm. In the case of wider flange face gaps, these sealing assemblies known from the prior art do not function properly.

The invention is therefore based on the task of adding a further well-functioning variant to these variations known from the prior art, which variant is designed for use in wide flange face gaps, i.e. in flange face gaps of about 5 mm and larger.

According to the invention, this task is accomplished by means of a sealing assembly for flat flange connections, having a ring-shaped metallic basic body consisting of a metal sheet, and ring-shaped soft-material linings present on both sides, wherein teeth or corrugations are embossed into the metallic basic body in ring shape, and the sealing assembly, in its original state, before installation into the flange connection, is characterized by the following combination of dimensions:
the sheet-metal thickness of the metallic basic body amounts to at least 0.5 mm, preferably at least 0.6 mm, even more preferably at least 0.8 mm, and even further preferably at least 1.0 mm,
the sheet-metal thickness of the metallic basic body amounts to at most 1.5 mm and preferably at most 1.2 the distance between the apices of two adjacent ring teeth facing in the same direction, in each instance, is greater than 3 mm and preferably greater than 4 mm,
the thickness of the metallic basic body, measured across the apices of the ring teeth, amounts to at least 2 mm and preferably at least 3 mm, the thickness of the metallic basic body, measured across the apices of the ring teeth, amounts to at most 6 mm, preferably at most 5 mm, and even more preferably at most 4 mm,
the soft-material linings present on both sides have a thickness, in each instance, of at least 1.5 mm, preferably at least 2.0 mm, and even more preferably at least 3.0 mm, and
the soft-material linings present on both sides have a thickness, in each instance, of at most 3.5 mm.

According to the invention, the task stated above is furthermore accomplished by means of a sealing assembly for flat flange connections, having a ring-shaped metallic basic body consisting of a metal sheet, and ring-shaped soft-material linings present on both sides, wherein four teeth or corrugations, having essentially the same embossed depth, in each instance, are embossed into the metallic basic body in ring shape, in such a manner that two of them, in each instance, face in the same direction, so that seen in cross-section, two of the four teeth or corrugations face upward and two of the said four teeth or corrugations face downward, and aside from the four said teeth or corrugations, no teeth or corrugations are present that are precisely as high as or higher than the four said teeth or corrugations, wherein the metallic basic body, seen in cross-section, within the region delimited by the four said teeth or corrugations, is a line that runs in the radial ring plane of the sealing assembly, or a straight line that runs at a slant, intersecting the radial ring plane of the sealing assembly, or has an embossed shape that runs in step shape or an embossed shape provided with spikes or corrugations, or an embossed shape having any other desired form, and the sealing assembly, in its original state, before installation into the flange connection, is characterized by the following combination of dimensions:
the sheet-metal thickness of the metallic basic body amounts to at least 0.5 mm, preferably at least 0.6 mm, even more preferably at least 0.8 mm, and even further preferably at least 1.0 mm,
the sheet-metal thickness of the metallic basic body amounts to at most 1.5 mm and preferably at most 1.2 mm,
the distance between the apices of the two adjacent ring teeth of the said four ring teeth that face in the same direction, in each instance, is greater than 3 mm, in each instance, and preferably greater than 4 mm, in each instance,
the thickness of the metallic basic body, measured across the apices of the said four ring teeth, amounts to at least 2 mm and preferably at least 3 mm,
the thickness of the metallic basic body, measured across the apices of the said four ring teeth, amounts to at most 6 mm, preferably at most 5 mm, and even more preferably at most 4 mm,
the soft-material linings present on both sides have a thickness, in each instance, of at least 1.5 mm, preferably at least 2.0 mm, and even more preferably at least 3.0 mm, and
the soft-material linings present on both sides have a thickness, in each instance, of at most 3.5 mm.

With regard to the embodiment of the sealing assembly according to the invention indicated in the preceding paragraph, those exemplary embodiments, in particular, in which the soft-material linings are situated at least within the region delimited by the four said teeth or corrugations are particularly advantageous. Each individual apex of the four said teeth or corrugations, independent of the state of the other apices, in each instance, can be covered with soft-material lining, or can be free of soft-material lining, and can be rounded off or not rounded off.

For all the embodiments of sealing assemblies according to the invention, it holds true that neither the ring-shaped soft-material linings nor the tooth embossings must extend over the entire radius of the ring-shaped metallic basic body in every case, although there are also such embodiments of sealing assemblies according to the invention.

Furthermore, it should be explicitly noted with regard to all embodiments of sealing assemblies according to the invention that it is not absolutely necessary for every ring tooth to be covered with soft-material lining, although there are also such embodiments of the sealing assembly according to the invention. Very generally, it is actually preferred that at least two of the highest ring teeth on each seal side are not covered with soft-material lining, so that in the installed state of the sealing arrangement, metallic contact occurs, in each instance, between the respective ring tooth and the respective flange face. Preferably, soft-material lining is then also present in the region between those last ring teeth mentioned, so that in the installed state of the sealing assembly, triple sealing occurs on both sides, in each instance: metallic on the inside, metallic on the outside, and, in between, soft-material sealing.

Furthermore, it should be explicitly noted that it is not absolutely necessary for any one at all of the ring teeth to be completely covered with soft-material lining, although there are also such embodiments of the sealing assembly according to the invention in which one ring tooth or multiple ring teeth is/are completely covered with soft-material lining.

It is true that according to the first embodiment of the sealing assembly according to the invention mentioned above, at least two ring teeth must be present, and according to the embodiment mentioned in second place above, at least four ring teeth must be present, but the sealing assemblies according to the invention can also have far more ring teeth or corrugations. The total number of ring teeth or corrugations is ultimately limited only by the concrete total diameter of the individual sealing assembly, in each instance. This diameter can amount to from a few centimeters to as much as several meters, depending on the size of the flange to be sealed.

In a preferred embodiment of the sealing assembly according to the invention, the metallic basic body is embossed in such a manner that in the region of the soft-material linings, seen in cross-section, it has the shape of two brackets lying on top of one another in opposite directions with a common leg, each bracket, in and of itself, being non-isosceles, or of a non-isosceles saw tooth curve having correspondingly differently steep flanks, wherein each individual apex formed by the metallic basic body or each individual tooth tip formed by the metallic basic body, independent of the corresponding state of the other apices or tooth tips formed by the metallic basic body, is covered with soft-material lining or free of soft-material lining, and rounded off or not rounded off. In the present connection, the word “non-isosceles” means that a leg of the respective bracket is shorter than the other leg of the respective bracket, and, in this regard, each of the two brackets therefore demonstrates asymmetry.

A particularly advantageous and preferred embodiment of the sealing assembly according to the invention is set up in such a manner that the legs of the two non-isosceles brackets that are different from the common leg separately, in each instance, form an angle of 45° to 90°, preferably of 55° to 65° or of 60° or of 60° to 90°, even more preferably of 75° to 90°, further preferably of 80° to 90°, and even further preferably of 85° to 90° or of 90° relative to the radial ring plane of the sealing assembly, so that the metallic basic body, in the region of the soft-material linings, has precisely or at least approximately the shape of a tipped-over “Z.” The radial ring plane of the sealing assembly mentioned above is a plane that runs parallel to the flange face surfaces against which the sealing assembly lies, in the installed state of the sealing assembly.

Preferably, the legs of the two non-isosceles brackets that are different from the common leg are shorter than the common leg.

Furthermore, the legs of the two non-isosceles brackets that are different from the common leg preferably have essentially the same length.

Further advantageous and preferred embodiments of the sealing assemblies according to the invention are the object of claims 8 to 15.

Exemplary embodiments of the sealing assemblies according to the invention will be explained below, using figures. These show:

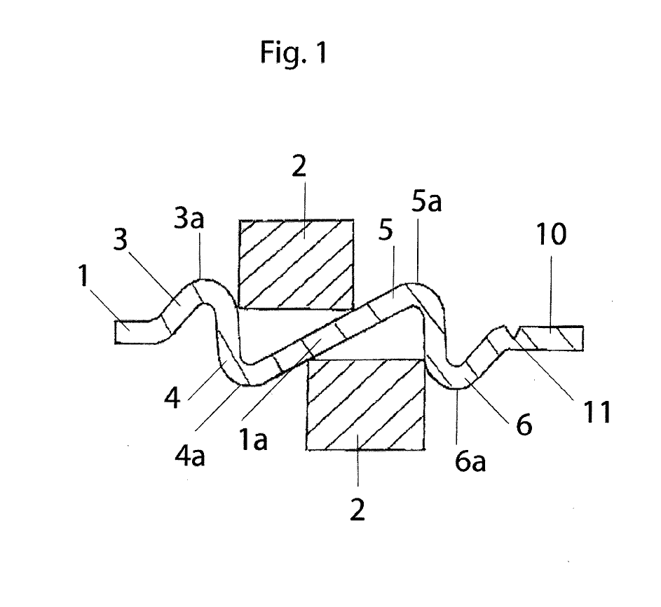

FIG. 1 in cross-section, schematically, half of a first exemplary embodiment of a sealing assembly according to the invention, in the original state, before installation into a flange,

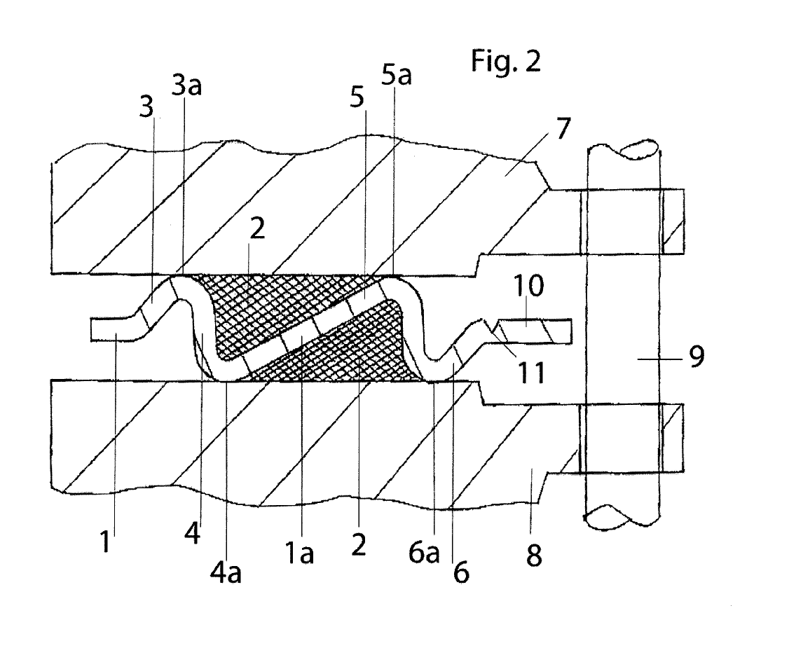

FIG. 2 in cross-section, schematically, the exemplary embodiment of FIG. 1, in the state installed in the flange, wherein metallic contact is produced between sealing assembly and flange,

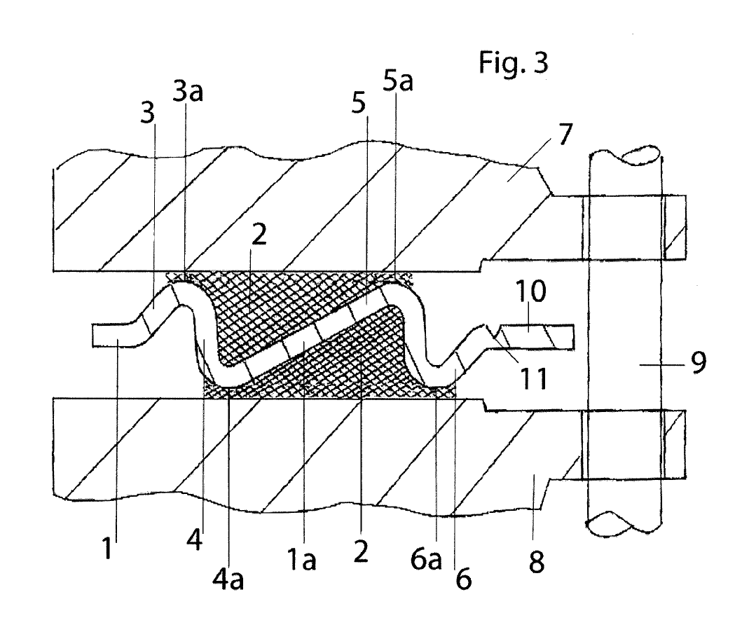

FIG. 3 in cross-section, in the installed state, a second exemplary embodiment, which is similar to that of FIGS. 1 and 2, but does not have any metallic contact with the flange,

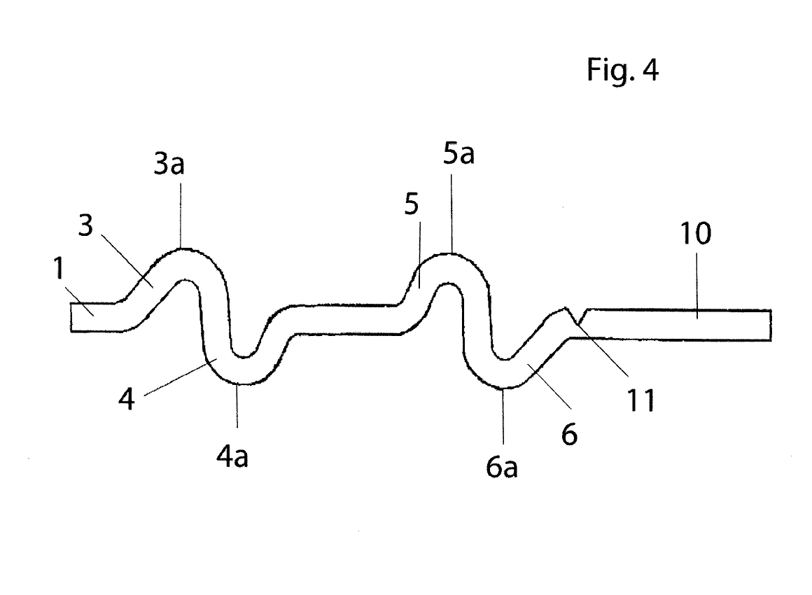

FIG. 4 in cross-section, schematically, half of a metallic basic body of a third exemplary embodiment of the sealing assembly according to the invention, and

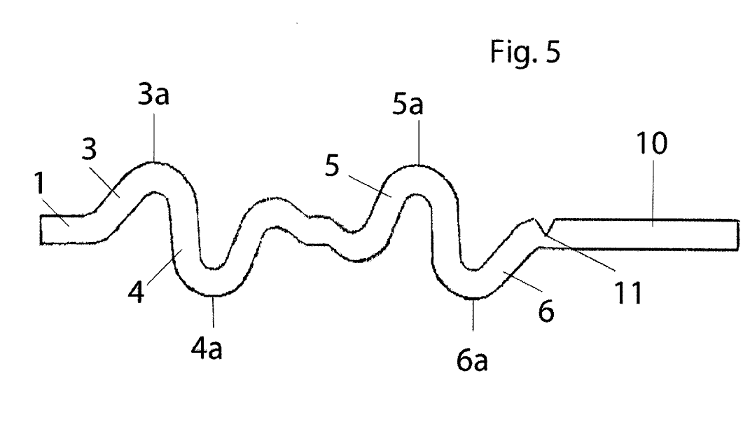

FIG. 5 in cross-section, schematically, half of the metallic basic body of a fourth exemplary embodiment of the sealing assembly according to the invention.

All the figures show purely schematic and not true-to-scale representations of essential parts of particularly preferred exemplary embodiments of the sealing assemblies according to the invention. In this regard, it will be easily evident to a person skilled in the art that both the definition, according to the invention, of the sealing assembly according to claim 1 and the definition, according to the invention, of the sealing assembly according to claim 2 comprise far more exemplary embodiments than the exemplary embodiments presented below as being particularly preferred and explained in greater detail using the figures.

FIGS. 1 to 3 show the cross-section of a sealing assembly according to the invention, which runs circumferentially in ring shape, in each instance, before (FIG. 1) and after (FIGS. 2 and 3) installation into a flange. FIGS. 4 and 5 each show only the cross-section of a metallic basic body 1 of a sealing assembly according to the invention, in each instance, which runs circumferentially in ring shape, in each instance. The soft-material linings 2 that are necessarily always present on the metallic basic body 1 on both sides, according to the invention, have been left out in the representations of FIGS. 4 and 5, for reasons of clarity.

In all five figures, the left side, in each instance, is the side facing the medium to be sealed off, and the right side, in each instance, is the side of the sealing assembly that faces the atmosphere. In other words, only the right half of the complete seal cross-section is shown in the figures, in each instance (FIGS. 1 to 3), and only the right half of the complete cross-section of the metallic basic body 1 is shown in the figures (FIGS. 4 and 5), wherein the representation of the left half is not required, because it is mirror-symmetrical to the right half shown. In other words: In a circumferential pass around the ring formed by the sealing assembly according to the invention, the seal cross-section formed by the sealing assembly according to the invention is the same at every location.

Hereinafter, the side facing the medium to be sealed off will also be designated with the term “on the inside,” because it faces the interior of the pipe or flange, and accordingly, the side facing the atmosphere will also be designated with the term “on the outside” hereinafter.

The exemplary embodiments of the sealing assemblies for flat flange connections, according to the invention, shown in the figures have a ring-shaped metallic basic body 1. Soft-material linings 2 that run circumferentially in ring shape are disposed on both sides of the metallic basic body 1 (in FIGS. 4 and 5, they are not shown, for the sake of clarity). In the exemplary embodiments shown, the soft-material linings 2 consist of graphite, and in the original state of the sealing assembly, i.e. before installation of the sealing assembly into a flange connection, they have a density of at least 0.7 g/cm³ and at most 1.5 g/cm³.

In other exemplary embodiments of sealing assemblies according to the invention, the soft-material linings 2 are composed of PTFE or other suitable materials. They can also have density values other than those indicated above.

The soft-material linings 2 are delimited, on the inside and on the outside, in each instance, by a radially circumferential tooth 3, 4, 5, 6 embossed into the metallic basic body, having a rounded-off tooth tip 3a, 4a, 5a, 6a, which produces metallic contact with the flange, in each instance, in the installed state of the sealing assembly, in the exemplary embodiment of FIG. 2, as is evident in FIG. 2. In this regard, the reference symbols 7 and 8 indicated the flange faces, and a flange screw is provided with the reference symbol 9 in FIG. 2.

In the installed state of the sealing assembly, triple sealing, in each instance, occurs in this manner in the exemplary embodiment of FIG. 2, namely metallic on the inside, metallic on the outside, and soft-material sealing in between, as can be seen in FIG. 2.

A particular feature of the exemplary embodiment of the sealing assembly according to the invention, according to FIG. 2, consists in that the metallic basic body 1 is embossed in such a manner that seen in cross-section, it intersects the soft material 2 diagonally, in a straight line la, and in this regard is guided in such a manner that in the installed state of the sealing assembly, it abuts against a flange face 8 with one end of the diagonal intersection line la and against the other flange face 7 of the flange with the other end of the diagonal intersection line 1a, in other words the diagonal intersection line 1a therefore forms the outer flank of one of the two inner teeth 4 and, at the same time, the inner flank of the specific outer tooth 5 that is situated on the side of the sealing assembly opposite to the last-mentioned inner tooth 4.

In this manner, improved metallic sealing to prevent cross-sectional leakage is achieved, for example as compared with the sealing assembly known from EP 1 062 442 B1. Furthermore, better flow of the soft material 2 is achieved, particularly if the soft material 2 is graphite. This in turn results in better sealing to prevent parting-surface leakage.

Furthermore, all the embodiments of the sealing assembly according to the invention are excellently suited for use in large flange face gaps of approximately 5 mm. This is guaranteed, in a first embodiment of the sealing assembly according to the invention, in that all the exemplary embodiments of the first embodiment of the sealing assembly according to the invention are designed in such a manner that in their original state, before installation into the flange connection, they have the following combination of dimensions:
the sheet-metal thickness of the metallic basic body 1 amounts to at least 0.5 mm, preferably at least 0.6 mm, even more preferably at least 0.8 mm, and even further preferably at least 1.0 mm,
the sheet-metal thickness of the metallic basic body 1 amounts to at most 1.5 mm and preferably at most 1.2 mm
the distance between the apices 3a, 4a, 5a, 6a of each of two adjacent ring teeth 3, 4, 5, 6 facing in the same direction, in each instance, is greater than 3 mm and preferably greater than 4 mm,
the thickness of the metallic basic body 1, measured across the apices 3a, 4a, 5a, 6a of the ring teeth 3, 4, 5, 6, amounts to at least 2 mm and preferably at least 3 mm,
the thickness of the metallic basic body 1, measured across the apices 3a, 4a, 5a, 6a of the ring teeth 3, 4, 5, 6, amounts to at most 6 mm, preferably at most 5 mm, and even more preferably at most 4 mm,
the soft-material linings 2 present on both sides have a thickness, in each instance, of at least 1.5 mm, preferably at least 2.0 mm, and even more preferably at least 3.0 mm, and
the soft-material linings 2 present on both sides have a thickness, in each instance, of at most 3.5 mm.

The exemplary embodiments of sealing assemblies according to the invention shown in the figures are different exemplary embodiments of a further, second embodiment of sealing assemblies according to the invention, very closely related to the first embodiment, wherein strictly speaking, this second embodiment is merely a special case of the first embodiment. All the exemplary embodiments of the second embodiment are, in each instance, a sealing assembly for flat flange connections, having a ring-shaped metallic basic body 1 consisting of a metal sheet, and ring-shaped soft-material linings 2 present on both sides, wherein four teeth or corrugations 3, 4, 5, 6 having essentially the same embossed depth are embossed into the metallic basic body 1 in ring shape, in such a manner that two of them, in each instance, face in the same direction, so that seen in cross-section, two of the said four teeth or corrugations 3, 5 face upward and two of the said four teeth or corrugations 4, 6 face downward, and aside from the four said teeth or corrugations 3, 4, 5, 6, no teeth or corrugations are present that are precisely as high as or higher than the four said teeth or corrugations 3, 4, 5, 6. The metallic basic body 1, seen in cross-section, within the region delimited by the four said teeth or corrugations 3, 4, 5, 6, is a line that runs in the radial ring plane of the sealing assembly (see the exemplary embodiment shown in FIG. 4), or a straight line la that runs at a slant, intersecting the radial ring plane of the sealing assembly (see the exemplary embodiment shown in FIGS. 1 to 3), or has an embossed shape that runs in step shape (see the exemplary embodiment shown in FIG. 5) or an embossed shape provided with spikes or corrugations, or an embossed shape having any other desired form. All of the exemplary embodiments of sealing assemblies according to the invention shown in the figures, in their original state, before installation into the flange connection, have the following combination of dimensions:
the sheet-metal thickness of the metallic basic body 1 amounts to at least 0.5 mm, preferably at least 0.6 mm, even more preferably at least 0.8 mm, and even further preferably at least 1.0 mm,
the sheet-metal thickness of the metallic basic body 1 amounts to at most 1.5 mm and preferably at most 1.2 mm,
the distance between the apices 3a, 5a; 4a, 6a of the two adjacent ring teeth of the said four ring teeth 3, 5; 4, 6 that face in the same direction, in each instance, is greater than 3 mm, in each instance, and preferably greater than 4 mm, in each instance, the thickness of the metallic basic body 1, measured across the apices 3a, 4a, 5a, 6a of the said four ring teeth 3, 4, 5, 6, amounts to at least 2 mm and preferably at least 3 mm,
the thickness of the metallic basic body 1, measured across the apices 3a, 4a, 5a, 6a of the said four ring teeth 3, 4, 5, 6, amounts to at most 6 mm, preferably at most 5 mm, and even more preferably at most 4 mm,
the soft-material linings 2 present on both sides have a thickness, in each instance, of at least 1.5 mm, preferably at least 2.0 mm, and even more preferably at least 3.0 mm, and
the soft-material linings 2 present on both sides have a thickness, in each instance, of at most 3.5 mm.

The essential difference between the first embodiment of sealing assemblies according to the invention and the second embodiment of sealing assemblies according to the invention consequently consists in that in the first embodiment, the distance between each of two adjacent ring teeth 3, 4, 5, 6 that face in the same direction, in each instance, is greater than 3 mm and preferably greater than 4 mm, in each instance, while this applies, in the case of the second embodiment of sealing assemblies according to the invention, only for the four highest ring teeth 3, 4, 5, 6, in each instance, between which and/or outside of which, however, in the case of the second embodiment, lower ring teeth having a lesser distance between teeth can then also be disposed. Furthermore, in the first embodiment, the heights of the teeth or corrugations present in the sealing assembly can be selected far more freely, in terms of their size ratio relative to one another, than in the second embodiment. Furthermore, in the second embodiment of sealing assemblies according to the invention, at least four ring teeth or corrugations 3, 4, 5, 6 are required, while in the first embodiment of sealing assemblies according to the invention, only at least two ring teeth or corrugations 3, 4, 5, 6 need to be present. However, all of the sealing assemblies according to the invention can also have far more ring teeth or corrugations, in varied exemplary embodiments. The total number of ring teeth or corrugations is ultimately limited only by the concrete total diameter of the individual sealing assembly, in each instance. This diameter can amount to from a few centimeters up to several meters, depending on the size of the flange to be sealed.

While the exemplary embodiment of FIG. 2, in the installed state, has four ring-shaped metallic contacts between the sealing assembly and the flange faces 7, 8, there are, however, also many types of different exemplary embodiments of sealing assemblies according to the invention in which fewer or more or even no metallic contacts at all occur between the sealing assembly and the flange faces 7, 8.

Thus, FIG. 3, for example, shows an exemplary embodiment of a sealing assembly according to the invention, in which, although it is very similar to the exemplary embodiment of FIG. 2, all the tooth tips 3a, 4a, 5a 6a are covered with soft material 2, so that no metallic contact with the flange faces 7, 8 occurs. Such an embodiment is particularly advantageous if the flange faces 7, 8 are supposed to be mechanically protected.

The exemplary embodiments of sealing assemblies according to the invention shown in the figures have a centering ring 10, which is already known as such to a person skilled in the art, from other sealing assemblies, and, as usual, serves for centering of the sealing assembly during installation into the flange.

The centering ring 10 of the exemplary embodiments of the sealing assemblies according to the invention shown in the figures is provided with a planned breaking point 11. A very essential point during installation of a sealing assembly into a flat flange connection specifically consists in that it is absolutely necessary to tighten the flange screws 9 uniformly and in proper technical manner. This is occasionally neglected by installers. In the event of loose flange screws 9 due to improper tightening of the flange screws 9, it can happen that the flanges are pressed apart from one another by the high internal pressure of the medium that flows in the pipelines. As a result, the centering ring 10 is put into vibration by medium that is flowing out, because of the gap on both sides. These vibrations of the centering ring 10, excited by the medium that is flowing out, are so strong that pieces of the centering ring 10 could break out, fly out of the flange connection in the manner of a projectile, and severely injure installers who are walking past or working in the vicinity. However, by providing the planned breaking point 11 in the centering ring 10, the result is achieved that the centering ring 10 breaks off completely, as soon as it starts to vibrate even slightly as the result of medium that might be flowing out. When the centering ring 10 breaks off, the vibrations are terminated immediately, and any risk for human beings is then excluded, at least in this regard.

In the exemplary embodiments of the sealing assembly according to the invention shown in the figures, the soft-material linings 2 are not yet completely pressed into the embossed depths of the teeth 3, 4, 5, 6 before installation of the sealing assembly into the flange (see FIG. 1). Only after installation of the sealing assembly into the flange does pressing of the soft material 2 also into the embossed depths of the teeth 3, 4, 5, 6 take place in the exemplary embodiments of the sealing assembly according to the invention shown in the figures, with tightening of the flange screws 9.

In other, particularly preferred exemplary embodiments of the sealing assembly according to the invention, the soft material 2 is already pressed into the embossed depth of the teeth 3, 4, 5, 6 to be filled with soft material 2 in the original state of the sealing assembly, i.e. before its installation into a flange, so that in these exemplary embodiments, a geometry as shown in FIG. 2 or in FIG. 3 already occurs, in those exemplary embodiments, for the corresponding sealing assemblies according to the invention, before installation into the flange.

In every case, it is particularly preferred to select the thickness and the density of the soft-material linings 2 in such a manner that the soft-material linings 2 are optimally compressed in the installed state of the sealing assembly according to the invention.

It is furthermore particularly preferred to structure the teeth 3, 4, 5, 6 in such a manner that they have a spring characteristic.

1. Sealing assembly for flat flange connections, having a ring-shaped metallic basic body (1) comprising a metal sheet, and ring-shaped soft-material linings (2) present on both sides, wherein teeth or corrugations (3, 4, 5, 6) are embossed into the metallic basic body (1) in ring shape, and the sealing assembly, in its original state, before installation into the flange connection, comprises the following combination of dimensions:
the sheet-metal thickness of the metallic basic body (1) amounts to at least 0.5 mm, preferably at least 0.6 mm, even more preferably at least 0.8 mm, and even further preferably at least 1.0 mm,
the sheet-metal thickness of the metallic basic body (1) amounts to at most 1.5 mm and preferably at most 1.2 mm,
the distance between the apices (3a, 4a, 5a, 6a) of each of two adjacent ring teeth (3, 4, 5, 6) facing in the same direction, in each instance, is greater than 3 mm and preferably greater than 4 mm,
the thickness of the metallic basic body (1), measured across the apices (3a, 4a, 5a, 6a) of the ring teeth (3, 4, 5, 6), amounts to at least 2 mm and preferably at least 3 mm,
the thickness of the metallic basic body (1), measured across the apices (3a, 4a, 5a, 6a) of the ring teeth (3, 4, 5, 6), amounts to at most 6 mm, preferably at most 5 mm, and even more preferably at most 4 mm,
the soft-material linings (2) present on both sides have a thickness, in each instance, of at least 1.5 mm, preferably at least 2.0 mm, and even more preferably at least 3.0 mm, and
the soft-material linings (2) present on both sides have a thickness, in each instance, of at most 3.5 mm.

2. Sealing assembly for flat flange connections, having a ring-shaped metallic basic body (1) comprising a metal sheet, and ring-shaped soft-material linings (2) present on both sides, wherein four teeth or corrugations (3, 4, 5, 6) having essentially the same embossed depth are embossed into the metallic basic body (1) in ring shape, in such a manner that
two of them, in each instance, face in the same direction, so that seen in cross-section, two of the said four teeth or corrugations (3, 5) face upward and two of the said four teeth or corrugations (4, 6) face downward, and
aside from the four said teeth or corrugations (3, 4, 5, 6), no teeth or corrugations are present that are precisely as high as or higher than the four said teeth or corrugations (3, 4, 5, 6),
wherein
the metallic basic body (1), seen in cross-section, within the region delimited by the four said teeth or corrugations (3, 4, 5, 6), is a line that runs in the radial ring plane of the sealing assembly, or a straight line (1a) that runs at a slant, intersecting the radial ring plane of the sealing assembly, or has an embossed shape that runs in step shape or an embossed shape provided with spikes or corrugations, or an embossed shape having any other desired form, and
the sealing assembly, in its original state, before installation into the flange connection, comprises the following combination of dimensions:
the sheet-metal thickness of the metallic basic body (1) amounts to at least 0.5 mm, preferably at least 0.6 mm, even more preferably at least 0.8 mm, and even further preferably at least 1.0 mm,
the sheet-metal thickness of the metallic basic body (1) amounts to at most 1.5 mm and preferably at most 1.2 mm,
the distance between the apices (3a, 5a; 4a, 6a) of the two ring teeth of the said four ring teeth (3, 5; 4, 6) that face in the same direction, in each instance, is greater than 3 mm, in each instance, and preferably greater than 4 mm, in each instance,
the thickness of the metallic basic body (1), measured across the apices (3a, 4a, 5a, 6a) of the said four ring teeth (3, 4, 5, 6), amounts to at least 2 mm and preferably at least 3 mm,
the thickness of the metallic basic body (1), measured across the apices (3a, 4a, 5a, 6a) of the said four ring teeth (3, 4, 5, 6), amounts to at most 6 mm, preferably at most 5 mm, and even more preferably at most 4 mm,
the soft-material linings (2) present on both sides have a thickness, in each instance, of at least 1.5 mm, preferably at least 2.0 mm, and even more preferably at least 3.0 mm, and
the soft-material linings (2) present on both sides have a thickness, in each instance, of at most 3.5 mm.

3. Sealing assembly according to claim 2, wherein the soft-material linings (2) are disposed at least within the region delimited by the four said teeth or corrugations (3, 4, 5, 6) and wherein each individual apex (3a, 4a, 5a, 6a) of the four said teeth or corrugations (3, 4, 5, 6), independent of the state of the other apices (3a, 4a, 5a, 6a), in each instance,
is covered with soft-material lining (2) or free of soft-material lining (2), and
is rounded off or not rounded off.

4. Sealing assembly according to claim 1, wherein the metallic basic body is embossed in such a manner that in the region of the soft-material linings (2), seen in cross-section, it has the shape of two angles lying on top of one another in opposite directions with a common leg (1a), each angle, in and of itself, being non-isosceles, or of a non-isosceles saw tooth curve having correspondingly differently steep flanks, wherein each individual apex (3a, 4a, 5a, 6a) formed by the metallic basic body (1) or each individual tooth tip (3a, 4a, 5a, 6a) formed by the metallic basic body (1), independent of the corresponding state of the other apices (3a, 4a, 5a, 6a) or tooth tips (3a, 4a, 5a, 6a) formed by the metallic basic body (1),
is covered with soft-material lining (2) or free of soft-material lining (2), and
rounded off or not rounded off.

5. Sealing assembly according to claim 4, wherein the legs of the two non-isosceles angles that are different from the common leg (1a) separately, in each instance, form an angle of 45° to 90°, preferably of 55° to 65° or of 60° or of 60° to 90°, even more preferably of 75° to 90°, further preferably of 80° to 90°, and even further preferably of 85° to 90° or of 90° relative to the radial ring plane of the sealing assembly, so that the metallic basic body (1), in the region of the soft-material linings (2), has precisely or at least approximately the shape of a tipped-over “Z.”

6. Sealing assembly according to claim 4, wherein the legs of the two non-isosceles angles that are different from the common leg (1a) are shorter than the common leg (1a).

7. Sealing assembly according to claim 4, wherein the legs of the two non-isosceles angles that are different from the common leg (1a) have essentially the same length.

8. Sealing assembly according to claim 4, wherein
the soft-material linings (2) present on both sides are delimited, on the inside and the outside, in each instance, by a radially circumferential tooth (3, 4, 5, 6) embossed into the metallic basic body (1), which tooth, in the installed state of the sealing assembly, produces metallic contact with the flange, in each instance, so that in the installed state of the sealing assembly, triple sealing occurs on both sides, in each instance, namely metallic on the inside, metallic on the outside, and soft-material sealing in between, and
the metallic basic body (1) is embossed in such a manner that seen in cross-section, it intersects the soft material (2) diagonally, in a straight line (1a), and in this regard is guided in such a manner that in the installed state of the sealing assembly, it abuts against a flange face (8) with one end of the diagonal intersection line (1a) and against the other flange face (7) of the flange with the other end of the diagonal intersection line (1a), in other words the diagonal intersection line (1a) therefore forms the outer flank of one of the two inner teeth (4) and, at the same time, the inner flank of the specific outer tooth (5) that is situated on the side of the sealing assembly opposite to the last-mentioned inner tooth (4).

9. Sealing assembly according to claim 1, wherein the teeth (3, 4, 5, 6) have a spring characteristic.

10. Sealing assembly according to claim 1, wherein the thickness and the density of the soft-material linings (2) are selected in such a manner that the soft-material linings (2) are optimally compressed in the installed state of the sealing assembly.

11. Sealing assembly according to claim 1, wherein the soft material (2) is already pressed into the embossed depths of the teeth or corrugations (4, 5) to be filled with soft material, even before installation of the sealing assembly into a flange.

12. Sealing assembly according to claim 1, comprising a centering ring (10).

13. Sealing assembly according to claim 12, wherein the centering ring (10) has a planned breaking point (11).

14. Sealing assembly according to claim 1, wherein the soft-material linings (2) comprise graphite or PTFE.

15. Sealing assembly according to claim 14, wherein the soft-material linings (2) comprise graphite and, in the original state, before installation of the sealing assembly into the flange connection, have a density of at least 0.7 g/cm³ and at most 1.5 g/cm³.

16. Sealing assembly according to claim 2, wherein the metallic basic body is embossed in such a manner that in the region of the soft-material linings (2), seen in cross-section, it has the shape of two angles lying on top of one another in opposite directions with a common leg (1a), each angle, in and of itself, being non-isosceles, or of a non-isosceles saw tooth curve having correspondingly differently steep flanks, wherein each individual apex (3a, 4a, 5a, 6a) formed by the metallic basic body (1) or each individual tooth tip (3a, 4a, 5a, 6a) formed by the metallic basic body (1), independent of the corresponding state of the other apices (3a, 4a, 5a, 6a) or tooth tips (3a, 4a, 5a, 6a) formed by the metallic basic body (1),
is covered with soft-material lining (2) or free of soft-material lining (2), and
rounded off or not rounded off.

17. Sealing assembly according to claim 5, wherein the legs of the two non-isosceles angles that are different from the common leg (1a) are shorter than the common leg (1a).

18. Sealing assembly according to claim 5, wherein the legs of the two non-isosceles angles that are different from the common leg (1a) have essentially the same length.

19. Sealing assembly according to claim 6, wherein the legs of the two non-isosceles angles that are different from the common leg (1a) have essentially the same length.

20. Sealing assembly according to claim 5, wherein
the soft-material linings (2) present on both sides are delimited, on the inside and the outside, in each instance, by a radially circumferential tooth (3, 4, 5, 6) embossed into the metallic basic body (1), which tooth, in the installed state of the sealing assembly, produces metallic contact with the flange, in each instance, so that in the installed state of the sealing assembly, triple sealing occurs on both sides, in each instance, namely metallic on the inside, metallic on the outside, and soft-material sealing in between, and
the metallic basic body (1) is embossed in such a manner that seen in cross-section, it intersects the soft material (2) diagonally, in a straight line (1a), and in this regard is guided in such a manner that in the installed state of the sealing assembly, it abuts against a flange face (8) with one end of the diagonal intersection line (1a) and against the other flange face (7) of the flange with the other end of the diagonal intersection line (1a), in other words the diagonal intersection line (1a) therefore forms the outer flank of one of the two inner teeth (4) and, at the same time, the inner flank of the specific outer tooth (5) that is situated on the side of the sealing assembly opposite to the last-mentioned inner tooth (4).

21. Sealing assembly according to claim 6, wherein
the soft-material linings (2) present on both sides are delimited, on the inside and the outside, in each instance, by a radially circumferential tooth (3, 4, 5, 6) embossed into the metallic basic body (1), which tooth, in the installed state of the sealing assembly, produces metallic contact with the flange, in each instance, so that in the installed state of the sealing assembly, triple sealing occurs on both sides, in each instance, namely metallic on the inside, metallic on the outside, and soft-material sealing in between, and
the metallic basic body (1) is embossed in such a manner that seen in cross-section, it intersects the soft material (2) diagonally, in a straight line (1a), and in this regard is guided in such a manner that in the installed state of the sealing assembly, it abuts against a flange face (8) with one end of the diagonal intersection line (1a) and against the other flange face (7) of the flange with the other end of the diagonal intersection line (1a), in other words the diagonal intersection line (1a) therefore forms the outer flank of one of the two inner teeth (4) and, at the same time, the inner flank of the specific outer tooth (5) that is situated on the side of the sealing assembly opposite to the last-mentioned inner tooth (4).

22. Sealing assembly according to claim 7, wherein
the soft-material linings (2) present on both sides are delimited, on the inside and the outside, in each instance, by a radially circumferential tooth (3, 4, 5, 6) embossed into the metallic basic body (1), which tooth, in the installed state of the sealing assembly, produces metallic contact with the flange, in each instance, so that in the installed state of the sealing assembly, triple sealing occurs on both sides, in each instance, namely metallic on the inside, metallic on the outside, and soft-material sealing in between, and
the metallic basic body (1) is embossed in such a manner that seen in cross-section, it intersects the soft material (2) diagonally, in a straight line (1a), and in this regard is guided in such a manner that in the installed state of the sealing assembly, it abuts against a flange face (8) with one end of the diagonal intersection line (1a) and against the other flange face (7) of the flange with the other end of the diagonal intersection line (1a), in other words the diagonal intersection line (1a) therefore forms the outer flank of one of the two inner teeth (4) and, at the same time, the inner flank of the specific outer tooth (5) that is situated on the side of the sealing assembly opposite to the last-mentioned inner tooth (4).

23. Sealing assembly according to claim 16, wherein the legs of the two non-isosceles angles that are different from the common leg (1a) separately, in each instance, form an angle of 45° to 90°, preferably of 55° to 65° or of 60° or of 60° to 90°, even more preferably of 75° to 90°, further preferably of 80° to 90°, and even further preferably of 85° to 90° or of 90° relative to the radial ring plane of the sealing assembly, so that the metallic basic body (1), in the region of the soft-material linings (2), has precisely or at least approximately the shape of a tipped-over “Z.”

24. Sealing assembly according to claim 16, wherein the legs of the two non-isosceles angles that are different from the common leg (1a) are shorter than the common leg (1a).

25. Sealing assembly according to claim 16, wherein the legs of the two non-isosceles angles that are different from the common leg (1a) have essentially the same length.

26. Sealing assembly according to claim 16, wherein
the soft-material linings (2) present on both sides are delimited, on the inside and the outside, in each instance, by a radially circumferential tooth (3, 4, 5, 6) embossed into the metallic basic body (1), which tooth, in the installed state of the sealing assembly, produces metallic contact with the flange, in each instance, so that in the installed state of the sealing assembly, triple sealing occurs on both sides, in each instance, namely metallic on the inside, metallic on the outside, and soft-material sealing in between, and
the metallic basic body (1) is embossed in such a manner that seen in cross-section, it intersects the soft material (2) diagonally, in a straight line (1a), and in this regard is guided in such a manner that in the installed state of the sealing assembly, it abuts against a flange face (8) with one end of the diagonal intersection line (1a) and against the other flange face (7) of the flange with the other end of the diagonal intersection line (1a), in other words the diagonal intersection line (1a) therefore forms the outer flank of one of the two inner teeth (4) and, at the same time, the inner flank of the specific outer tooth (5) that is situated on the side of the sealing assembly opposite to the last-mentioned inner tooth (4).

27. Sealing assembly according to claim 2, wherein the teeth (3, 4, 5, 6) have a spring characteristic.

28. Sealing assembly according to claim 2, wherein the thickness and the density of the soft-material linings (2) are selected in such a manner that the soft-material linings (2) are optimally compressed in the installed state of the sealing assembly.

29. Sealing assembly according to claim 2, wherein the soft material (2) is already pressed into the embossed depths of the teeth or corrugations (4, 5) to be filled with soft material, even before installation of the sealing assembly into a flange.

30. Sealing assembly according to claim 2 comprising a centering ring (10).

31. Sealing assembly according to claim 30, wherein the centering ring (10) has a planned breaking point (11).

32. Sealing assembly according to claim 1, wherein the soft-material linings (2) comprise graphite or PTFE.

33. Sealing assembly according to claim 32, wherein the soft-material linings (2) comprise graphite and, in the original state, before installation of the sealing assembly into the flange connection, have a density of at least 0.7 g/cm³ and at most 1.5 g/cm³.
